(19) United States
(12) Patent Application Publication
(10) Pub. No.: US 2025/0284500 A1
(43) Pub. Date: Sep. 11, 2025

(54) METHOD FOR SELECTING STARTUP PROGRAMS

(71) Applicant: STMicroelectronics International N.V., Geneva (CH)

(72) Inventor: Jawad BENHAMMADI, pont de claix (FR)

(21) Appl. No.: 19/061,468

(22) Filed: Feb. 24, 2025

(30) Foreign Application Priority Data
Mar. 8, 2024 (FR) FR2402333

(51) Int. Cl. G06F 9/4401; G06F 21/57

(52) U.S. Cl. CPC G06F 9/4403; G06F 9/441; G06F 21/575; G06F 2221/034

(57) ABSTRACT

A method of selection of a boot program for a microprocessor of a microcontroller is provided. The method comprising selecting a boot program, from among a plurality of boot programs contained in one or a plurality of memories of the microcontroller, wherein a plurality of registers of the microcontroller are read first during a resetting of the microprocessor and this reading conditions, together with a state of at least one signal present on a boot pin of the microcontroller, the selection of the boot program.

### CROSS REFERENCE TO RELATED APPLICATION(S)

This application claims the priority benefit of French patent application number FR2402333, filed on Mar. 8, 2024, entitled “Procédé de sélection de programmes de démarrage”, which is hereby incorporated by reference to the maximum extent allowable by law.

### TECHNICAL FIELD

The present disclosure generally concerns methods for selecting boot programs in microprocessors of microcontrollers, as well as microcontrollers implementing such methods.

### BACKGROUND

Many electronic circuits, such as microcontrollers, including systems on chip (SOC), comprise an architecture which enables to select the security level for the resources and memories used by the applications implemented in these circuits.

However, certain architectures do not enable, basically, to choose between a plurality of security levels.

### BRIEF SUMMARY

There exists a need to provide methods to enable to choose to implement a plurality of security levels in a circuit having an architecture which does not enable, basically, to choose between a plurality of security levels.

An embodiment overcomes all or part of the disadvantages of known methods.

An embodiment provides a method of selection of a boot program for a microprocessor of a microcontroller, from among a plurality of boot programs contained in one or a plurality of memories of the microcontroller, wherein a plurality of registers f the microcontroller are read first during a resetting of the microprocessor, and this reading conditions, together with a state of at least one signal present on a boot pin of the microcontroller, the selection of the boot program.

According to an embodiment, a first boot program for a system memory of the microcontroller is configured to, when it is selected, implement a configuration of the microprocessor so that it is in a single security mode.

According to an embodiment, the single security mode is a first security mode where, when a non-secure transaction requires access to a secure resource of the microprocessor, an error is returned.

According to an embodiment, in the first security mode, when a secure transaction requires access to a non-secure resource of the microprocessor, then an error is returned.

According to an embodiment, the first boot program is configured to modify a value of a security register representative of the size of a forbidden access region of the system memory containing the first boot program, so that at least the first boot program is not accessible.

According to an embodiment, the value of the security register can only be incremented.

According to an embodiment, the modification of the value of the security register consists in an increase greater than one bit.

According to an embodiment, at least one application is executable from a user memory of the microcontroller, different from the system memory and configured with the first security mode, after the selection of the first boot program.

According to an embodiment, the system memory is a read-only memory or a memory configured to operate as a read-only memory.

According to an embodiment, at the initialization of the system, if:
a first option register has a first value;
a second option register has a second or a third value; and
the signal present on the boot pin is in a first state;
then the first boot program is selected from the system memory.

According to an embodiment, at the initialization of the system, if:
the first option register has the first value;
the second option register has the second value; and
the signal present on the boot pin is in a second state;
then a second boot program is selected from the system memory.

According to an embodiment, at the initialization of the system, if:
the first option register has the first value; and
the second option register has a value from among a fourth, a fifth, and a sixth values; and
the signal present on the boot pin is in the first or in the second state;
then the first boot program is selected from the system memory.

According to an embodiment, at the initialization of the system, if:
the first option register has the seventh value;
the second option register has the second value; and
the signal present on the boot pin is in the first state;
then a third boot program is selected from a user memory different from the system memory.

According to an embodiment, at the initialization of the system, if:
the first option register has a seventh value;
the second option register has the second or the third value; and
the signal present on the boot pin is in a second state;
then a boot program, different from the first program, selected from the system memory.

An embodiment provides a microcontroller, comprising a microprocessor, a system memory, and a user memory, and configured to implement the method such as described hereabove.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an example of an integrated circuit of the type to which the described embodiments apply;

FIG. 2 illustrates a implementation mode of a method of selection of boot programs for the circuit of FIG. 1; and

FIG. 3 illustrates another implementation mode of a method of selection of boot programs for the circuit of FIG. 1.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

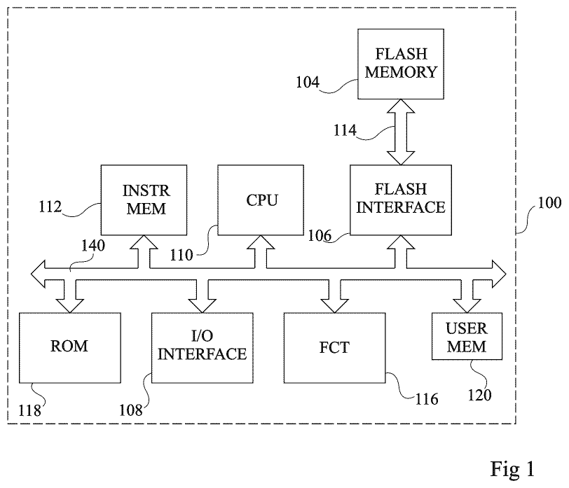

FIG. 1 shows, very schematically and in the form of blocks, an example of an electronic circuit 100 of the type to which the described embodiments apply.

Circuit 100 comprises a non-volatile memory 104 (FLASH MEMORY), for example of FLASH memory type, capable of communicating, via a communication bus 114, with a non-volatile memory interface 106 (FLASH INTERFACE) configured to write or read data into and from non-volatile memory 104. In an example, system programs and/or applications, such as boot programs, are implemented in memory 104.

Circuit 100 further comprises, for example, a processing unit 110 (CPU) comprising one or a plurality of processors under control of instructions stored in a system instruction memory 112 (INSTR MEM). Instruction memory 112 is, for example, a volatile random access memory (RAM). Processing unit 110 and memory 112 communicate, for example, via a system (data, address, and control) bus 140. FLASH memory 104 is coupled to system bus 140 via non-volatile memory interface 106 and via bus 114. Device 100 further comprises an input/output interface 108 (I/O interface) coupled to system bus 140 to communicate with the outside.

Circuit 100 further comprises, for example, another memory 120 (USER MEM) of non-volatile type or of RAM type. This memory 120 is coupled to system bus 140 directly or via a (non-illustrated) memory interface having a role, for example, similar to interface 106.

Device 100 may integrate other circuits implementing other functions (for example, one or a plurality of volatile and/or non-volatile memories, other processing units), symbolized by a block 116 (FCT) in FIG. 1. Among these other circuits, circuit 100 comprises, for example, a read-only or static memory 118 (ROM).

One or a plurality of boot programs for the circuit are for example directly transferred into memory 104 during factory programming processes. The boot program(s) must not be modified once transferred into flash memory 104, unless circuit 100 is reset. For this purpose, it is provided to lock the access to the flash memory area containing the boot program, so that it is impossible to access thereto without a reboot. This is for example achieved by implementing a register (HDPL), for example monotonically increasing, having its value representative of the size of a forbidden access region of the memory containing the boot program(s), so that the boot program(s) are not accessible. For example, when the value of register HDPL is 1, the boot program which is located in a memory region associated with value 1 can be executed. After the execution, value HDPL is incremented to 2, which forbids the access to the boot program located in the memory region associated with value 2. If a second boot program has been loaded into the memory in sectors between HDPL1 and HDPL2, then it can be executed, after which value HDPL is incremented to 3, which forbids the access to the two boot programs located in the memory regions associated with value 1 and 2. Applications are then for example implemented in the memory without having the same access restriction level.

In certain architectures, such as for example those of ARM® v8.0-M or ARM® CORTEX® M33 type, by selecting an option during the development, for example by changing the value of a user option byte, the circuit resources or memories, but also certain programs, may be partitioned with different security levels. This mechanism is called in these examples “Trustzone”. A first security level (secure) is for example implemented by establishing that when a non-secure transaction requires access to a secure resource of the microprocessor, then an error is returned, for example, over bus 140 and when a secure transaction requires access to a non-secure resource of the microprocessor, then an error is also returned. The rest of the circuit and/or of the programs is then for example implemented with less stringent security principles, where for example programs having a security level lower than the first level can only access the non-secure resources and memories of circuit 100.

In certain architectures, such as for example those of ARM® CORTEX® M85 or ARMV8.1-M type, there is no option to choose whether or not to partition the circuit resources, memories, and programs with different security levels. In these architectures, only the high security level is made available. In other words, in these architectures, the “Trustzone” mechanism is not natively capable of being deactivated. There thus basically is an isolation (for example called TZIsolation) between resources, memories, or programs having the first security level and a less secure mode. This may raise issues to enable to easily develop applications which do not require implementing a security isolation, such as for example the “Trustzone” mechanism, or which simply do not need being secured.

The described embodiments provide implementing a method of selection of a boot program for a microprocessor of a microcontroller, from among a plurality of boot programs contained in one or a plurality memories of the of microcontroller, in which a plurality of registers of the microcontroller are first read during a resetting of the microprocessor and this reading conditions, together with a state of at least one signal present on a boot pin of the microcontroller, the selection of the boot program.

This enables to do away, for example, with the systematical implementation of a system for partitioning the resources, memories, or programs between a plurality of security levels. It is thus possible to obtain a single security level or to generate one and the same security level for all the resources, memories, and programs used.

This further enables to obtain a software solution enabling to facilitate the development of applications which do not require a high security level. Such a mode is for example known as “legacy”.

This further enables a boot program, enabling to do away with the systematical implementation of a resource partitioning system, to be integrated as native code by the manufacturer, directly into a system memory containing all the manufacturer's programs. An resulting advantage is that a user memory, different from the system memory, can thus be completely vacated.

Further, this ensures the portability of programs previously developed on architectures which still enabled to choose, by means of the changing of user option bytes, the activation of a partitioning of the resources, memories, or program between a plurality of security levels.

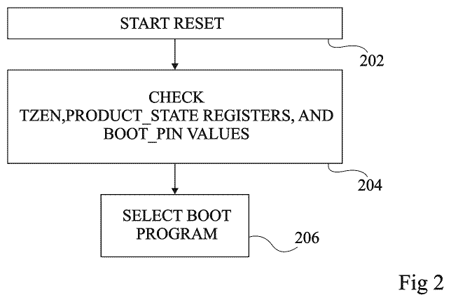

FIG. 2 illustrates an implementation mode of a method of selection of boot programs for the microcontroller of FIG. 1. More specifically, the shown example illustrates a method of selection of boot programs for processing unit 110, in other words for a microprocessor, of microcontroller 100. These boot programs are present either in a user memory, for example memory 120, or in a so-called system memory, such as memory 104 or 112.

At a step 202 (START RESET), microprocessor 110 is reset, for example with an interruption of the power supply or by the implementation of specific commands.

In a subsequent step 204 (CHECK TZEN, PRODUCT_STATE REGISTERS, AND BOOT_PIN VALUES), a plurality of registers TZEN, PRODUCT_STATE of microcontroller 100, as well as a state of at least one signal present on a boot pin (BOOT_PIN) of microcontroller 100, are read first. The values of registers TZEN or PRODUCT_STATE are called user option bytes.

Register TZEN corresponds, for example, to a register present in older architectures, for example of ARM® v8.0-M or ARM® CORTEX® M33 type. In these old architectures, they enabled to choose whether to implement a partitioning of the resources of the microprocessor, for example if TZEN=1, or on the contrary not to implement a partitioning, for example in the case where TZEN=0. In new architectures, natively, such a register is no longer taken into account, and a partitioning is basically implemented. Here, the value of this register is read out, even if it does not enable, as such, to disable the basic partitioning of microprocessor 110.

The value of register PRODUCT_STATE corresponds to a state in the life cycle of microcontroller 100. Register PRODUCT_STATE may comprise a plurality of values. At the time of the manufacturing, the state is entered as “OPEN”, then “PROVISIONING”, then “PROVISIONED”, then “TZ-CLOSED”, then “CLOSED” or “LOCKED”. These different states of register PRODUCT_STATE may be used to enable different subcontractors to intervene during the manufacture of microcontroller 100.

The “OPEN” state corresponds to the factory default state of the microcontroller. It allows the configuration of the boot program, the establishing of a protection with a security register (HDPL) having a value representative of the size of a forbidden access region of the system memory. In this state, the debugging is open with no limits.

The “PROVIONING” state corresponds to a state of the microcontroller in which the debugging is only open for applications for which the value of the security register (HDPL) is greater than a given number, for example 3. In this state, an encryption is carried out on the data areas containing security keys.

The “PROVISIONED” state, otherwise known as “iROT-PROVISIONED”, corresponds to a state subsequent to the “PROVIONING” state. In this state, certain programs used at the booting as well as data are no longer accessible. From this state, higher levels can be updated.

The “TZ-CLOSED” state corresponds to a state in which the programs which use resources dedicated to the “secure” security mode of the “Trustzone” architecture have been installed. In this state, applications dedicated to the other “non-secure” security mode can be developed or loaded.

The “CLOSED” and then “LOCKED” states correspond to the final stage of the product. In the “CLOSED” state, all debugging accesses are closed and are only accessible by strong authentication. With this strong authentication, a regression is however possible. In the “LOCKED” state, all debugging accesses are closed, including with a strong authentication.

The state of the signal(s) present on one or a plurality of the boot pins BOOT_PIN of microcontroller 100 corresponds, for example, to a high (1) or low (0) state. The user may choose to apply, for example, a voltage VDD for the high state or the ground for the low state to this pin.

The reading from registers TZEN and PRODUCT_STATE as well as the reading of the state on the boot pin BOOT_PIN of microcontroller 100, is performed first after the resetting.

At a step 206 (SELECT BOOT PROGRAM), subsequent to step 204, the values read from registers TZEN and PRODUCT_STATE, and of the state on the boot pin BOOT_PIN of microcontroller 100, condition the selection of the boot program.

The selection operation consists in implementing the boot program, which is stored in one or a plurality of memory areas, each delimited, for example, by two or more memory addresses.

The selection may be performed from a system memory, such as memories 104, 112 for a more secure application, but also from a user memory, for example memory 120. In an example, system memory 104, 112 cannot be written into or read from by the user, who only has access to user memory 120.

Thus, the user, who is for example a subcontractor or a professional user integrating the microcontroller into their products, can implement their application with the required security level, during a microcontroller customization phase, from user memory 120.

Table 1 below corresponds, for example, to a databank which is used as a reference for the selection of the boot program (BOOT_SELEC), or equivalently of the memory area corresponding to this program, according to the values read from registers TZEN and PRODUCT_STATE, and to the state on the boot pin BOOT_PIN, but also optionally of a register called BOOT_UBE.

TABLE 1

| | PRODUCT_{—} | BOOT_{—} | BOOT_{—} | BOOT_{—} |
|---|---|---|---|---|
| TZEN | STATE | PIN | UBE | SELEC |
| 0 | OPEN | 0 | N/A | ST-iNoIsolation |
| 0 | | 1 | N/A | Bootloader |
| 0 | PROVISIONING | N/A | N/A | ST-iNoIsolation |
| 0 | PROVISIONED, | N/A | N/A | ST-iNoIsolation |
| | CLOSED, | | | |
| | LOCKED | | | |
| 1 | OPEN | 0 | N/A | User mem |
| 1 | OPEN | 1 | 0xB4 | Bootloader |
| 1 | OPEN | 1 | 0xC3 | STiROT |
| 1 | PROVISIONING | N/A | N/A | RSS |
| 1 | PROVISIONED, | N/A | 0xC3 | STiROT |
| 1 | TZ-CLOSED, | N/A | 0xB4 | User mem |
| | CLOSED, | | | |
| | LOCKED | | | |

In TABLE 1, value N/A means that the result of the selection does not depend on the value in the corresponding box containing N/A.

Programs ST-iNoIsolation, Bootloader, STiROT, and RSS are for example stored in different system memory areas 104, 112. These programs are for example protected by monotonically increasing values of security register HDPL.

According to Table 1, it is possible for a boot program to be selected from a user memory 120 (User mem), for example when TZEN=1, PRODUCT_STATE=0, and BOOT_PIN=0.

According to Table 1, when option register TZEN has a value 0, when register PRODUCT_STATE has value OPEN or PROVISIONING, and the signal present on boot pin BOOT_PIN is 0, then address area ST_iNoIsolation, or equivalently the boot program ST_iNoIsolation present in this address area, is selected from the system memory.

When option register TZEN has a value 0, and register PRODUCT_STATE has a value PROVISIONING, then boot program ST_iNoIsolation is selected from the system memory, regardless of the state of pin BOOT_PIN.

The same applies when TZEN has value 0, and the second option register PRODUCT_STATE has a value from among values PROVISIONED, CLOSED, or LOCKED; and this, whatever the state of the signal present on boot pin BOOT_PIN.

Boot program ST_iNoIsolation is configured to, when it is selected, configure microprocessor 110 so that it is in a single secure or non-secure security mode, according to the value of TZEN. By selecting the boot program ST_iNoIsolation stored in system memory 104, 112, it becomes possible to initialize applications in user memory 120 with the same security mode. Boot program ST_iNoIsolation is further configured to initialize the entire memory seen by the application (non-volatile and volatile memories) in the same security mode, for example secure. In other words, program ST-iNoIsolation emulates the selected security mode. The applications implemented, for example by a customer or a subcontractor, in user memory 120, will be implemented in the security mode selected with TZEN.

Optionally, program ST_iNoIsolation is configured to change value HDPL from HDPL1 to HDPL3 to prevent functions of the secure boot program(s) from being implemented in system memory 104, 112 once executed.

Optionally, program ST_iNoIsolation is configured to allow debugging for memory areas having value HDPL3 only. In addition, it may be configured to implement an authentication method for accessing the debugging which is a password level and not a certificate.

Once program ST_iNoIsolation has been selected, microprocessor 110 implements an application, in user memory 120, with the security mode provided by register TZEN.

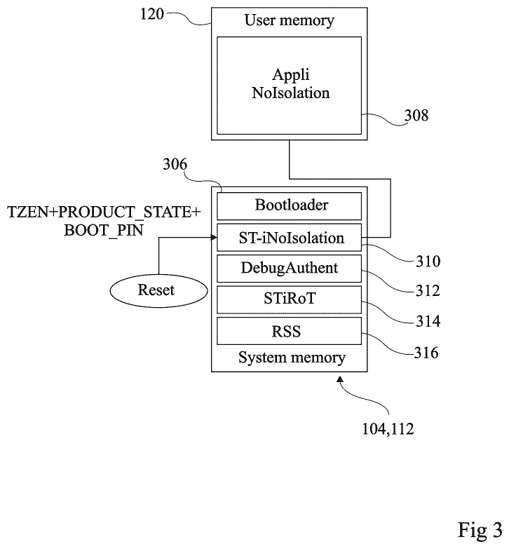

FIG. 3 illustrates another implementation mode of a method of selection of boot programs for the circuit of FIG. 1. More particularly, the shown example describes user memory 120, and system memory 104, 112.

In the shown example, system memory 104, 112 is configured, for example, to emulate a read-only memory (ROM).

In the shown example, system memory 104, 112 comprises programs 316 (RSS), 314 (STiROT) which are, for example, successive previously loaded boot programs and, for example, protected by areas using increasing HDPL values.

In FIG. 3, system memory 104, 112 further comprises program 312 (DebugAuthent), which is located, for example, between a memory address dedicated to program 314 (STiROT) and a memory address dedicated to program 310 (ST-iNoIsolation). Program 312 is called, for example, when an authentication for debugging is provided. System memory 104, 112 also comprises program 306 (Bootloader) located after an end-of-program memory address 310 (ST-iNoIsolation). In an example, this memory area having boot program ST-iNoIsolation stored therein cannot be modified once loaded (immutable).

During a resetting of microprocessor 110, registers TZEN and PRODUCT_STATE are read, as well as the state of the signal on pin the BOOT_PIN. If these values correspond, using TABLE 1, to program ST-iNoIsolation—or equivalently to the memory area corresponding to program ST-iNoIsolation—then the microprocessor will start by the execution of program ST-iNoIsolation, which will configure the microprocessor, and possibly the entire microcontroller 100, so that it is in a single secure or non-secure mode such as defined by the value of register TZEN. Microprocessor 110 will then execute application 308 (Appli NoIsolation), from user memory 120. The entire memory 120 is thus available to the user, who is for example a subcontractor.

The fact that microprocessor 110 could not itself natively provide the input for selecting the security mode thus becomes transparent to the user, since the choice is reintroduced through the use of register TZEN associated with program ST-iNoIsolation.

Various embodiments and variants have been described. Those skilled in the art will understand that certain features of these various embodiments and variants may be combined, and other variants will occur to those skilled in the art. In particular, the selection of the boot program may be performed while also taking into account the value of register BOOT_UBE, as shown in table TABLE 1.

Finally, the practical implementation of the described embodiments and variants is within the abilities of those skilled in the art based on the functional indications given hereabove. In particular, regarding the values in table TABLE 1, those skilled in the art will be able to modify these values as they wish, while at the same time trying to maintain a transparency of use on register TZEN with respect to previous uses.

1. A method of selection of a boot program for a microprocessor of a microcontroller from among a plurality of boot programs contained in one or more of a plurality of memories of the microcontroller, the method comprising:
reading a plurality of registers of the microcontroller during a resetting of the microprocessor; and
selecting, in response to reading of one or more conditions together with a state of at least one signal present on a boot pin of the microcontroller, the boot program.

2. The method of claim 1, wherein a first boot program of a system memory of the microcontroller is configured to, when it is selected, implement a configuration of the microprocessor so that it is in a single security mode.

3. The method of claim 2, wherein the single security mode is a first security mode where, when a non-secure transaction requires access to a secure resource of the microprocessor, an error is returned.

4. The method of claim 3, wherein, in the first security mode, when a secure transaction requires access to a non-secure resource of the microprocessor, then an error is returned.

5. The method of claim 2, wherein the first boot program is configured to modify a value of a security register representative of a size of a forbidden access region of the system memory containing the first boot program, so that at least the first boot program is not accessible.

6. The method of claim 5, wherein the value of the security register can only be incremented.

7. The method of claim 6, wherein a modification of the value of the security register consists in an increase greater than one bit.

8. The method of claim 2, wherein at least one application is executable from a user memory of the microcontroller, different from the system memory and configured with a first security mode, after a selection of the first boot program.

9. The method of claim 2, wherein the system memory is a read-only memory or a memory configured to operate as a read-only memory.

10. The method of claim 2 further comprising:
selecting, at an initialization of a system, the first boot program from the system memory if:
a first option register has a first value;
a second option register has a second or a third value; and
the signal present on the boot pin is in a first state.

11. The method of claim 10 further comprising:
selecting, at the initialization of the system, a second boot program from the system memory if:
the first option register has the first value;
the second option register has a second value; and
the signal present on the boot pin is in a second state.

12. The method of claim 10 further comprising:
selecting, at the initialization of the system, the first boot program from the system memory if:
the first option register has the first value;
the second option register has a value from among a fourth, a fifth, and a sixth value; and
the signal present on the boot pin is in the first state or in the second state.

13. The method of claim 10 further comprising:
selecting, at the initialization of the system, a third boot program from a user memory different from the system memory if:
the first option register has a seventh value;
the second option register has a second value; and
the signal present on the boot pin is in a first state.

14. The method of claim 10 further comprising:
selecting, at the initialization of the system, a boot program, different from the first program, from the system memory if:
the first option register has a seventh value;
the second option register has the second or the third value; and
the signal present on the boot pin is in a second state.

15. A microcontroller, comprising a microprocessor, a system memory, and a user memory, and configured to implement the method of claim 1.

16. A method of selection of a boot program for a microprocessor of a microcontroller from among a plurality of boot programs contained in one or a plurality of memories of the microcontroller, wherein:
selecting a boot program after a first register and a second register of the microcontroller are read first during a resetting of said microprocessor and this reading conditions, together with a state of at least one signal present on a boot pin of the microcontroller; and
wherein a value of the first register defines whether a partitioning of the microprocessor is implemented, and a value of the second register defines a life-cycle state of the microcontroller.
